(19) United States
(12) Patent Application Publication
(10) Pub. No.: US 2003/0051801 A1
(43) Pub. Date: Mar. 20, 2003

(54) Screen printing plate, method and device for manufacturing the same, screen printing method and device, and screen-printed matter

(75) Inventors: Hiroyuki Usami, Ebina-shi (JP); Naoki Morita, Ebina-shi (JP); Hiroaki Satoh, Ebina-shi (JP); Shuichi Yamada, Ebina-shi (JP); Hiroshi Ikeda, Ebina-shi (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 10/087,909

(22) Filed: Mar. 5, 2002

(30) Foreign Application Priority Data
Sep. 18, 2001 (JP) 2001-283910

(51) Int. Cl. B44C 1/00

(52) U.S. Cl. 156/240; 118/500

(57) ABSTRACT

A screen printing plate which includes an ink permeable member through which ink permeates, and an ink blocking material which adheres to the ink permeable member and blocks permeation of ink. The fluid ink blocking material is ejected onto the ink permeable member. Alternatively, the fluid ink blocking material is ejected onto an intermediate transfer member and then transferred onto the ink permeable member. The ink blocking material solidifies on the ink permeable member, thereby forming a pattern of ink blocking material on the ink permeable member. The ink blocking material is preferably ejected using an ink jetting device.

### BACKGROUND OF THE INVENTION

1. Field of the Invention

The present invention relates to a screen printing plate and a method and a device for manufacturing the same, a screen printing method and a screen printing device in which the screen printing plate is used, and a screen-printed matter obtained using the screen printing plate.

2. Description of the Related Art

Screen printing has been widely used as a technique for enabling printing onto materials and shapes, such as cloths, plastic, printed circuit boards, porcelains, metal plates, cubes, and curved surfaces, onto which printing with other printing techniques is difficult.

A direct plate-making process, an indirect plate-making process, and a direct and indirect plate-making process are known as conventional plate-making processes for plates for screen printing (i.e., screen printing plates).

In the direct plate-making process, first, as shown in FIG. 1A, a photosensitive resin emulsion 2 is applied onto a meshed screen 1, which has been set in a frame, and is dried. Subsequently, the photosensitive resin emulsion 2 is made to contact a positive film which includes a transparent sheet 4 and a pattern 5 previously formed on the transparent sheet 4. The positive film is then irradiated with light 3 and developed (see FIG. 1B), thereby obtaining a screen printing plate 6. Then, the screen printing plate 6 thus obtained is set in a screen printer, and, as shown in FIG. 1C, ink 7 is placed onto the screen printing plate 6. The ink 7 is applied by a squeegee 8 onto a material to be printed 9, such as paper or cloth. The ink 7 passes through a permeable portion (i.e., mesh portion) of the screen 1, thereby printing an image 10 onto the material to be printed 9 (see FIG. 1D). However, this process requires advanced techniques for uniformly applying the emulsion, work in a dark room, and a large number of processings and facilities. Further, this process has problems such as unclear pattern edges due to dust adhering to the pattern or irregular reflections of light off of the mesh.

In the indirect plate-making process, as shown in FIG. 2A, a pattern 12 is formed in advance on a film-shaped substrate 11 by exposure, development, and the like. Next, the substrate 11 is superposed onto a meshed screen 15 such that the pattern 12 contacts the screen 15. Subsequently, the substrate 11 is removed so that only the pattern 12 is transferred to the screen 15 (FIG. 2B). As shown in FIG. 2C, the plate thus obtained is set in a screen printer so that the pattern 12 faces the material to be printed 9, such as paper or cloth. Subsequently, the ink 7 is placed onto the plate and spread by the squeegee 8 such that the pattern 12 is printed on the material to be printed 9. The ink 7 passes through a mesh portion, thereby printing the image 10 onto the material to be printed 9 (see FIG. 2D). In this process, a film having a transfer agent coated thereon is separately purchased, and a pattern is formed on the film in advance. Thus, unlike the direct plate-making process, this process does not particularly require the emulsion application technique, suffers no irregular reflections of the light off of the mesh, and can provide a resolution near the resolution obtained by the positive film. However, a problem arises in that the adhesion strength between the pattern and the screen is low, and sufficient durability cannot be maintained. Therefore, this process is disadvantageous in mass printing, and it is difficult to maintain a constant quality of printed images.

The direct and indirect plate-making process has been devised in order to combine the simplicity of the indirect plate-making process with advantages of the direct plate-making process such as strength. Namely, as shown in FIGS. 3A through 3E, a film 16 for direct and indirect screen printing having a photosensitive resin layer 17 coated on one side thereof is adhered to the meshed screen 1 set in a frame. Thereafter, the film 16 is removed. A photosensitive resin layer 18 can be easily formed on the screen 1 by applying water or a photosensitive resin solution to the screen 1 on the side to which the photosensitive resin layer 17 is not adhered, and drying the water or the photosensitive resin solution. Subsequently, as shown in FIG. 3C, using a positive film 19, the photosensitive resin layer 17 is exposed and developed. A screen printing plate 20 thus obtained is set in a screen printer, the ink 7 is placed on the screen printing plate 20, and printing is carried out on the material to be printed 9, such as paper or cloth, by using the squeegee 8. The ink 7 passes through the mesh portion, thereby printing the image 10 on the material to be printed 9 (see FIG. 3E). In this process, since the photosensitive resin layer 17 is adhered to the screen 1 by supplying water or the photosensitive resin solution onto the side of the screen 1 opposite to the side to which the photosensitive resin layer 17 is adhered, adhesion strength is stronger than that in the indirect plate-making process. Since the emulsion is protected by the film 16 until shortly before the exposure, the emulsion has a certain level of durability and is hardly affected by dirt and dust.

Various conventional problems are solved by using the direct and indirect plate-making process. However, since the printing plate is essential to screen printing, when the amount of printing is small, the printing plate increases the printing cost. Namely, there is a demand for inexpensive printing plates in applications for hobbies or applications in which various types of printing plates are used for a small amount of printing such as only one print.

In response to such demands, various methods for directly forming an image on a material to be printed using the ink jet technique have been proposed. However, the ink jet technique imposes many restrictions on ink which can be used. For example, problems arise in that a coloring material corresponding to the material to be printed cannot be prepared as an ink-jet printing ink which does not affect recording, or, even if such an ink can be prepared, images of good hue cannot be obtained. For example, it is difficult for an image directly obtained by the ink jet technique to achieve the depth and three-dimensionality, which are unique characteristics of screen printing.

As described above, the techniques which have been heretofore proposed have only simplified printing processes, and it is difficult to say that these techniques can be used in place of screen printing.

Printing on materials to be printed, such as cloths, plastic, printed circuit boards, porcelains, and metal plates, is mainly carried out by screen printing.

An example of techniques for manufacturing screen printing plates is Japanese Patent Application Laid-Open (JP-A) No. 2001-30450, in which a screen printing plate can be easily manufactured by the following process. First, a printed image layer is formed on a transparent resin film layer of a photosensitive resin film for screen printing plates by printing using the ink jet technique, which film is comprised of the transparent resin film layer and a photosensitive resin layer. Next, the printed image layer is adhered to a screen set in a frame and is exposed. Thereafter, the transparent resin film layer is removed, and the photosensitive resin layer is developed with water. However, the printed image layer formed by ink jet printing is a mask during exposure, rather than an area which blocks ink during screen printing. Further, since the exposure and development processings are necessary, this technique does not sufficiently simplify the screen printing process or reduce costs.

Moreover, JP-A No. 11-277712 proposes a method which does not require irradiation with light. Namely, JP-A No. 11-277712 proposes a technique for manufacturing a screen printing plate in which a stencil layer is formed on any supporting substrate and transferred onto a screen. The solubility of the stencil layer becomes low when it reacts with a chemical applied by ink jetting, and unreacted portions of the stencil layer can be removed by water or the like. In this case, exposure is unnecessary. However, an image formed by applying a chemical by ink jetting only serves as a latent image, and the area blocking ink during screen printing is made visible through a subsequent processing of development with water. Therefore, this technique, also, does not sufficiently simplify the screen printing process or reduce costs.

As described above, a technique which can form an area blocking printing ink during screen printing directly on a meshed screen, which meshed screen serves as a screen printing plate, makes many processes and facilities unnecessary, and can manufacture a screen printing plate at a lower cost, has not been provided at present.

### SUMMARY OF THE INVENTION

Accordingly, the present invention is provided to solve the conventional problems and achieve the following objects.

An object of the present invention is to provide a screen printing plate which includes a sharply patterned ink blocking material and can form a printed image with high resolution. Another object of the present invention is to provide a method and a device for manufacturing a screen printing plate in which a screen printing plate, which has no unclear pattern edges due to irregular reflection of light caused by exposure, can form a pattern having sharp edges, and can form a printed image at high resolution, can be simply manufactured in a small number of steps and at low cost.

Yet another object of the present invention is to provide a screen printing method and a screen printing device in which the screen printing plate of the present invention is used to obtain a printed image of high resolution, and printing can be carried out at low cost even at the time of printing in a small amount. Still another object of the present invention is to provide a screen-printed matter which is printed at high resolution by using the screen printing plate of the present invention.

In order to solve the above-described problems, a first aspect of the present invention is a screen printing plate comprising: an ink permeable member through which ink can permeate; a pattern of ink blocking material adhered to the ink permeable member and blocking the permeation of ink through the ink permeable member; and the ink blocking material comprising a solidified fluid material which is ejected onto the ink permeable member.

The ink blocking material adhering to the ink permeable member may be solidified by applying at least one of pressure and heat to the fluid material on the ink permeable member.

A second aspect of the present invention is a screen printing plate comprising: an ink permeable member through which ink can permeate; and a pattern of ink blocking material adhered to the ink permeable member and blocking the permeation of ink through the ink permeable member, the ink blocking material comprising a solidified fluid material, which has been ejected onto a transfer member and transferred from the transfer member to the ink permeable member.

In the screen printing plate according to the first and second aspects of the present invention, the ink blocking material may be ejected using an ink jetting device.

Further, the ink permeable member of the screen printing plate may have a mesh portion.

The screen printing plate may include a supporting substrate for supporting the ink permeable member. The supporting substrate may have an opening so that the surface of the ink permeable member is exposed. Moreover, all or a portion of the supporting substrate may be removably provided.

In the screen printing plate according to the first and second aspects of the present invention, the ink blocking material may contain wax.

Further, the ink blocking material may be solid at a temperature no more than room temperature (preferably 50° C. or less).

Furthermore, the ink blocking material may be photo-curable.

In the screen printing plate according to the first and second aspects of the present invention, the ink blocking material may contain a photo-curing agent.

A third aspect of the present invention is a method for manufacturing a screen printing plate, comprising the steps of: providing an ink permeable member through which ink can permeate; and ejecting a fluid ink blocking material for blocking permeation of ink onto the ink permeable member such that a pattern of ink blocking material adheres to the ink permeable member, thereby forming the pattern of ink blocking material on the ink permeable member.

A fourth aspect of the present invention is another method for manufacturing a screen printing plate, comprising the steps of: providing a transfer member; ejecting a fluid ink blocking material for blocking permeation of ink onto a transfer member such that a pattern of ink blocking material adheres to the transfer member; providing an ink permeable member through which ink can permeate; and transferring the pattern of ink blocking material adhering to the transfer member onto the ink permeable member such that the pattern of ink blocking material is formed on the ink permeable member.

In the methods for manufacturing a screen printing plate according to the third and fourth aspects of the present invention, the ink blocking material may be ejected using an ink jetting device.

A fifth aspect of the present invention is a device for manufacturing a screen printing plate from an ink permeable member through which ink can permeate using ink blocking material which adheres to the ink permeable member for blocking permeation of ink, wherein the device includes an ejection means for ejecting a fluid ink blocking material onto the ink permeable member so as to form a pattern of ink blocking material thereon.

The device for manufacturing a screen printing plate may include a means for applying at least one of pressure and heat to the ink blocking material on the ink permeable member.

A sixth aspect of the present invention is a device for manufacturing a screen printing plate from an ink permeable member through which ink can permeate using ink blocking material which adheres to the ink permeable member for blocking permeation of ink, the device comprising: a transfer member; an ejection means for ejecting onto the transfer member a fluid ink blocking material for forming a pattern of ink blocking material; and a transfer means for transferring the pattern of ink blocking material on the transfer member to the ink permeable member, whereby the pattern of ink blocking material is formed on the ink permeable member.

The ejection means may have an ink jet ejection mechanism.

A screen printing method, which includes a step of screen-printing an image on a material to be printed by using the screen-printing plates of the first and second aspects of the present invention, is provided.

Moreover, a screen printing device, which includes a printing means for screen-printing an image on a material to be printed by using the screen-printing plates of the first and second aspects of the present invention, is provided.

Further, a screen-printed matter is provided by using the screen printing method and the screen printing device described above.

### BRIEF DESCRIPTION OF THE DRAWINGS

FIGS. 1A through ID are drawings showing a process for manufacturing a screen printing plate in accordance with a conventional direct plate-making process.

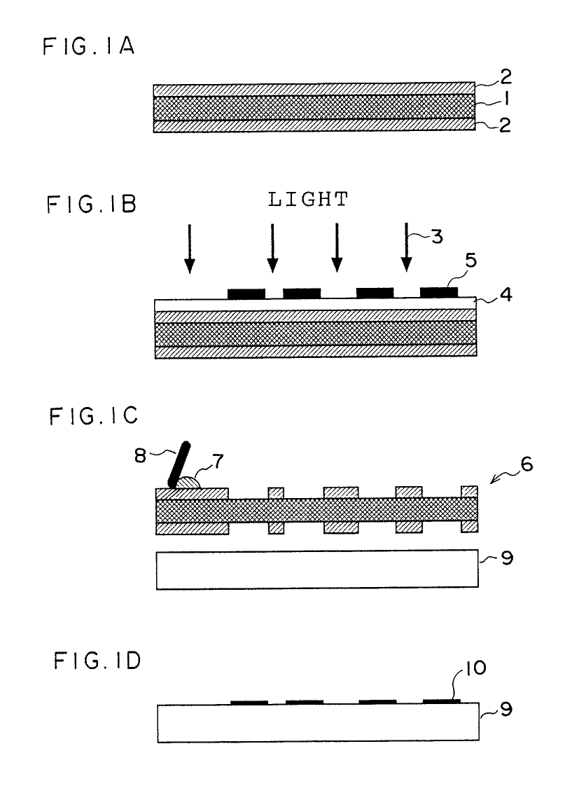

FIGS. 2A through 2D are drawings showing a process for manufacturing a screen printing plate in accordance with a conventional indirect plate-making process.

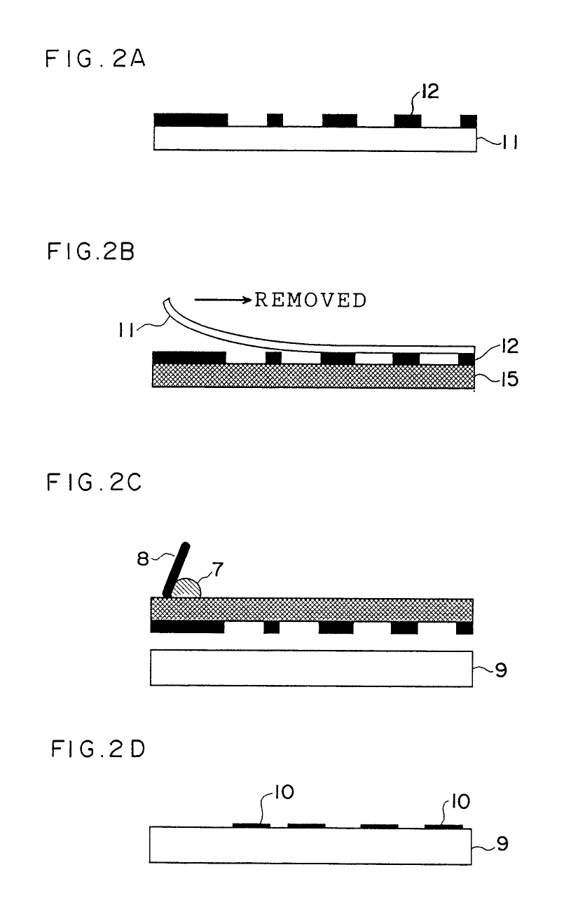

FIGS. 3A through 3E are drawings showing a process for manufacturing a screen printing plate in accordance with a conventional direct and indirect plate-making process.

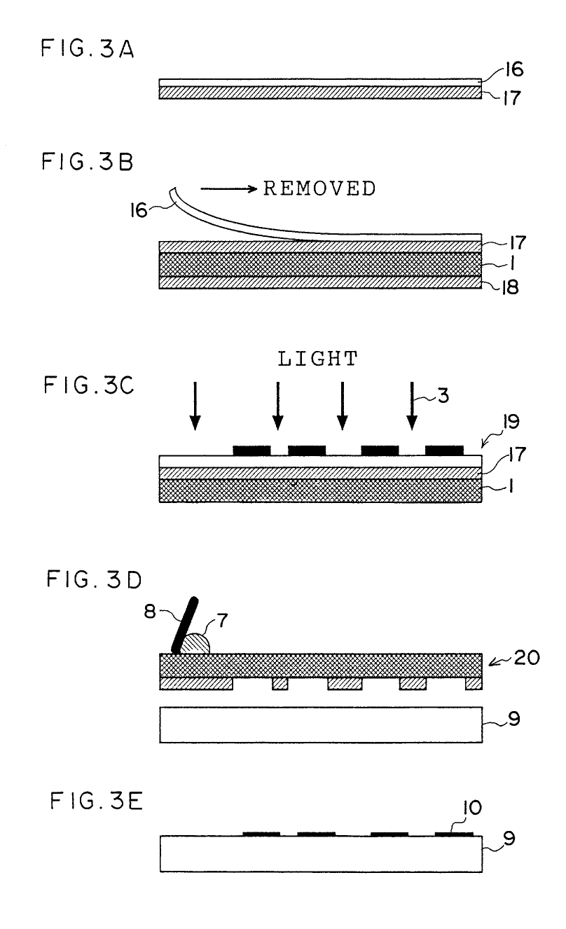

FIG. 4 is a schematic process drawing for explaining an example in which a screen printing plate in accordance with a first aspect of the present invention is manufactured.

FIGS. 5A and 5B are schematic process drawings for explaining an example in which a screen printing plate in accordance with a second aspect of the present invention is manufactured.

FIG. 6 is a perspective view showing an example of a screen printing device in accordance with the present invention.

FIG. 7 is a schematic view showing an example of a system for manufacturing a screen printing plate using a device for manufacturing a screen printing plate in accordance with the present invention.

FIGS. 8A through 8C are schematic process drawings for explaining an example in which the screen printing plate in accordance with the second aspect of the present invention is manufactured.

FIG. 9A is a perspective view showing an example of the screen printing device in accordance with the present invention, and FIG. 9B is a view showing an example of a screen-printed matter obtained by screen printing.

FIGS. 10A through 10D are schematic process drawings for explaining the process for screen-printing an image on a curved surface in accordance with a screen printing method of the present invention.

### DESCRIPTION OF THE PREFERRED EMBODIMENTS

A screen printing plate according to the present invention has a pattern formed thereon by an ink blocking material. The pattern of ink blocking material is formed by ejecting a fluid ink blocking material onto an ink permeable member so that the fluid ink blocking material adheres to the ink permeable member and blocks the permeation by ink. The ink blocking material is preferably ejected by using an ink jetting device. In a method and a device for manufacturing a screen printing plate in accordance with the present invention, the fluid ink blocking material is preferably ejected by using an ink jetting device. Further, in a screen printing method and a screen printing device in accordance with the present invention, screen printing is carried out using the screen printing plate of the present invention. A screen-printed matter in accordance with the present invention is produced by using the screen printing method and the screen printing device of the present invention.

Hereinafter, the screen printing plate and the manufacturing method therefor will be described in detail. Further, in the description, the device for manufacturing a screen printing plate, the screen printing method, the screen printing device, and the screen-printed matter will be presented in detail.

<Screen Printing Plate>

The screen printing plate of the present invention includes an ink permeable member through which ink passes and a pattern of ink blocking material which adheres to the ink permeable member and blocks the permeation by ink. The pattern of ink blocking material is formed by a fluid ink blocking material, which is ejected onto the ink permeable member.

The pattern of ink blocking material of the present invention is formed by using the fluid ink blocking material and preferably by ejecting the fluid ink blocking material directly onto the ink permeable member by using an ink jetting device. Therefore, application of a photosensitive material is not necessary. As a result, processings such as exposure and development are not necessary, and the screen printing plate can be obtained simply and at low cost. Further, the resolution is not decreased by unclear pattern edges (i.e., contour portions lacking in sharpness and thus being unclear) which would otherwise be caused by dust adhering to the pattern or by irregular reflections of light off of a mesh, and therefore, sufficient durability can be ensured. Consequently, printed images of high resolution can be stably formed.

In the screen printing plate of the present invention, the ink permeable member forms an area through which ink can permeate during printing. When ink is applied, an ink image is formed on a material to be printed, which is disposed at the side of the screen printing plate opposite to the side where the ink is applied.

The ink permeable member may be formed of any material as long as printing ink can pass through it. The ink permeable member can be appropriately selected from known materials. Among them, a material having a mesh portion is preferable. A mesh portion refers to a portion having, for example, meshed or net-like holes or gaps. Holes and gaps may have any shape.

Further, the material for the ink permeable member can be appropriately selected from materials typically used in screen printing, such as nylon, silk, polyester, polyallylate, polyamide, stainless steel, and the like.

Among ink permeable members, the ink permeable member having a mesh size of 80 to 500 lines/inch is preferable, and the ink permeable member having a mesh size of 150 to 400 lines/inch is more preferable.

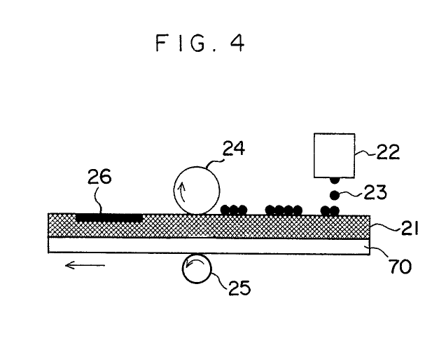

Moreover, the screen printing plate preferably includes a supporting substrate for supporting the ink permeable member. For example, as shown in FIG. 4, an ink permeable member 21 may be supported by a supporting substrate 70. With the screen printing plate formed only by the ink permeable member such as a meshed member, sufficient strength cannot be ensured when the screen printing plate is conveyed in a device for manufacturing a screen printing plate. Thus, the screen printing plate having a supporting substrate which can reinforce the mesh portion and maintain the shape of the mesh portion is preferable.

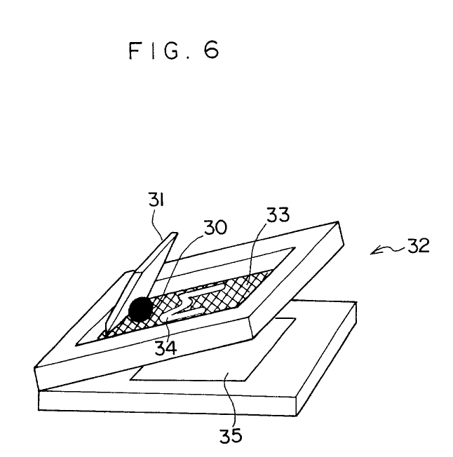

The supporting substrate may be provided at the entire surface of the ink permeable member. For example, as shown in FIG. 6, the supporting substrate may have an opening so that the surface of the ink permeable member, namely, the mesh portion, is exposed. The supporting substrate may also be provided so that all or a portion thereof can be removed by peeling.

The material for the supporting substrate can be appropriately selected from known materials such as resins, cardboard, films, and the like. Stainless steel, aluminum, lumber, or the like can be used depending on the manufacturing conditions and conditions of use for the screen printing plate.

A pattern of ink blocking material which blocks ink is formed on the ink permeable member in accordance with an image to be printed. The pattern of ink blocking material blocks permeation of ink through the screen printing plate during printing.

It is preferable that the ink blocking material is not affected by ink, firmly adheres to the ink permeable member, and has excellent long-term durability. Material which can obtain these characteristics when solid is used as the ink blocking material. In particular, a material which is solid at room temperature or less (50° C. or less) and melts into a liquid by heating (i.e., a hot melt material) is preferable. Examples of such a material include wax, thermoplastic resins, and mixtures thereof.

Further, plasticizers, tackifiers, and curing agents such as photo-curing agents (UV curing agents and the like) may be appropriately added to the ink blocking material.

Wax can be selected from various types of wax materials, including animal and vegetable wax, mineral wax, petroleum wax such as paraffin wax and microcrystalline wax, fatty acid wax such as polyethylene wax, stearic acid wax, and ester wax, synthetic wax, fatty acid amide-containing materials, sulfonamide materials, other natural resin materials, and the like. Moreover, examples of the thermoplastic resins include synthetic resins such as amide resins, polyester resins, polyvinyl acetate resins, acrylic acid resins, methacrylic acid resins, styrene resins, silicone resins, and urethane resins. In either case, it is preferable that suitable materials are appropriately selected in consideration of durability in printing, resistance to ink, resistance to solvents, and the like.

An ink blocking material which is colored by adding a color material such as a pigment or a dye can also be used. The color material can be appropriately selected from known color materials.

Among ink blocking materials, a photo-curing material (photo-curing ink blocking material) is particularly preferable. With the ink blocking material having the photo-curing characteristic, strength (i.e., durability) of the pattern of ink blocking material can be easily improved by irradiating the pattern of ink blocking material with light.

The photo-curing ink blocking material may be a liquid preparation of a photo-curing resin containing monomers, oligomers, and a photopolymerization initiator, or a wax having a photo-curing resin added thereto as a photo-curing agent. The monomers forming the photo-curing resin are organic materials which become large molecules and form the resin by polymerization. The oligomers are materials which are obtained in advance by reacting the monomers and form the resin by polymerization as well. The photopolymerization initiator is an additive which causes polymerization reactions on the monomers and the oligomers.

Photopolymerizable oligomers are classified into those cured by radical polymerization reactions and those cured by cationic polymerization reactions. Examples of the former include urethane acrylate oligomers, epoxy acrylate oligomers, ester acrylate oligomers, and acrylate oligomers. Examples of the latter include epoxy oligomers and vinyl ether oligomers.

Examples of the photopolymerization initiator include benzoyl isopropyl ether, benzophenone, Michler's ketone, chlorothioxanthone, isopropylthioxanthone, and benzyldimethylketal.

As for the photo-curing resin, the materials described above are suitable. The photo-curing resin may be added in any amount as long as it does not adversely affect durability in printing, resistance to ink, or resistance to solvents.

Examples of the plasticizer include ester phthalate plasticizers, adipate plasticizers, phosphate plasticizers, and polyester plasticizers. The plasticizer may be added in any amount as long as it does not adversely affect durability in printing, resistance to ink, or resistance to solvents.

An example of the tackifier is a terpene polymer.

The melting point of the ink blocking material is preferably 70 to 200° C., and more preferably 80 to 140° C.

Further, the viscosity of the fluid ink blocking material is preferably 1 to 20 mPa·s, and more preferably 1 to about 15 mPa·s. When the viscosity exceeds 20 mPa·s, the ink blocking material cannot be ejected from an ink jet head.

The ink blocking material according to the present invention is preferably a material which is insoluble in a solvent such as acetone, toluene, or a thinner (a diluent). Even if the ink blocking material dissolves in such a solvent, the ink blocking material preferably dissolves in such a trace amount that it causes no adverse effect on the print quality.

The thickness of the pattern of ink blocking material formed of the ink blocking material is preferably the same as or larger than the thickness of the ink permeable member (i.e., the thickness of the mesh).

The screen printing plate in accordance with the present invention can be manufactured by ejecting (preferably by using an ink jetting device) the fluid ink blocking material directly onto a desired ink permeable member or onto an intermediate transfer member when the intermediate transfer member is used, such that the pattern of ink blocking material for blocking permeation by ink is directly formed on the ink permeable member. Specifically, the screen printing plate can be preferably manufactured by a manufacturing method thereof in accordance with the present invention, the details of which will be described below.

<Method for Manufacturing a Screen Printing Plate>

The method for manufacturing a screen printing plate in accordance with the present invention includes at least a step of ejecting a fluid ink blocking material for forming a pattern of ink blocking material. In this ejection step, the pattern of ink blocking material is directly formed by ejecting the ink blocking material imagewise.

Specifically, the above-described screen printing plate can be preferably manufactured in accordance with the following first and second embodiments. First and second embodiments relate to methods for manufacturing screen printing plates in accordance with the first and second aspects of the present invention, respectively.

The method for manufacturing a screen printing plate in accordance with the first aspect of the present invention includes at least a step of ejecting a fluid ink blocking material onto an ink permeable member through which ink passes, such that the ink blocking material adheres to the ink permeable member and thereby forms a pattern of ink blocking material for blocking ink. Further, this method preferably includes a curing step. With this method, a screen printing plate having the ink permeable member and the pattern of ink blocking material is manufactured.

In this embodiment, the fluid ink blocking material is directly applied imagewise onto the ink permeable member, preferably by using an ink jetting device. Thus, exposing and developing are unnecessary, and no decrease in image sharpness is caused by irregular reflections of light. As a result, the pattern of ink blocking material having very sharp edges can be formed.

In the ejection step, the fluid ink blocking material is adhered by being ejected onto the ink permeable member through which ink passes.

Any method of ejecting the ink blocking material may be used as long as it enables ejection of the fluid ink blocking material. Preferably, the ejection method is appropriately selected from known methods in which images can be formed by application of the ink blocking material. The ink jet method is particularly preferable among such methods.

Three typical examples of the ink jet method are a continuously synchronized jetting method in which ink is electrostatically deflected, a jetting method in which ink is pressurized and jetted by electrically turning on or off piezoelectric elements, and an ink-on-demand or drop-on-demand method in which ink is heated so as to be jetted. The jetting method is preferable among these methods.

Further, a particularly preferable method in the present invention is a hot melt ink jet method in which the ink blocking material which is solid at room temperature is heated and melted such that the ink blocking material which has been melted (i.e., in a fluid state) is ejected.

The temperature during heating and melting of the ink blocking material is preferably 70 to 200° C., and more preferably 80 to 140° C.

Details of and the preferable conditions for the ink blocking material used are as described above.

When the ink blocking material is ejected jetted) onto the ink permeable member, the ink blocking material is adhered mainly to the surface of the ink permeable member. Therefore, in order to fill in the ink permeable member with the ink blocking material and smooth the surface of the screen printing plate which is finally obtained, it is preferable that the manufacturing method include a step of pressing and/or heating the ink blocking material which has been ejected onto the ink permeable member (i.e., a smoothing step). In the smoothing step, only one of pressure and heat may be applied, or both pressure and heat may be applied.

In order to press the ink blocking material, for example, a structure such as a pair of cylindrical (solid or hollow) pressure rollers of any diameters, or pressure plates formed by two flat plates can be used. However, the means for pressing the ink blocking material is not limited to these structures.

For example, the ink blocking material is filled in the ink permeable member in high density and the surface of the screen printing plate is smoothed by the ink permeable member having the ink blocking material applied thereon being conveyed between a pair of rollers which rotate so as to contact and press against each other, such that the ink permeable member having the ink blocking material applied thereon is pressed by the rollers. Consequently, durability of the screen printing plate can be significantly improved. Further, irregularities on the surface of the screen printing plate are suppressed, and ink can be smoothly and uniformly applied onto the screen printing plate during printing.

The pressure applied to the ink blocking material varies depending on the fineness of the mesh of the ink permeable member. However, the pressure is preferably 2 MPa or more, and more preferably 4 to 6.5 MPa.

When the pressure is less than 2 MPa, the ink blocking material cannot be sufficiently filled into the ink permeable member, and therefore, a screen printing plate having the ink blocking material (pattern) of sufficient durability might not be obtained.

When the ink blocking material is heated, a heating means which can soften or melt the ink blocking material can be appropriately selected from among known heating means.

Further, it is also preferable to use heating rollers or hot plates at the time of applying pressure, so that the screen printing plate is heated while being pressed. By pressing the ink blocking material, which has solidified on the ink permeable member, in a softened or melted state, the ink blocking material can be filled into the ink permeable member more easily and in higher density. As a result, the surface of the screen printing plate can be smoothed, and the pressure used can be reduced.

The temperature for heating the ink blocking material is preferably 70 to 100° C.

Moreover, after the ejection step is finished, or after the smoothing step, which is subsequent to the ejection step, is finished, a step of irradiating at least the ink blocking material (pattern of ink blocking material) with light (i.e., a curing step) may be provided in order to harden the ink blocking material which has been applied to the ink permeable member.

As described above, in the case of the photo-curing ink blocking material, the strength of the pattern of ink blocking material finally obtained by irradiating the ink blocking material with light can be further improved. As a result, the screen printing plate having high durability can be obtained.

Details regarding a light source and conditions for irradiating the ink blocking material with light will be described later in the “Device for Manufacturing a Screen Printing Plate” section.

FIG. 4 is a schematic view for explaining an example in which the screen printing plate in accordance with the first aspect of the present invention is manufactured.

A hot melt ink jet head 22 is disposed so that ejection orifices thereof face the ink permeable member formed by a screen mesh 21. The screen mesh 21 is conveyed to the left as shown by the arrow. Pressure rollers 24 and 25 for pressing the hot melt ink 23 against the screen mesh 21 are disposed at the downstream of the ink jet head 22 on the conveying path of the screen mesh 21.

The screen mesh 21, which is formed ultimately as a screen printing plate, is supported by the supporting substrate 70 and conveyed at a constant speed in the direction shown by the arrow while the hot melt ink 23 is jetted (ejected) imagewise from the hot melt ink jet head 22 onto the screen mesh 21. The hot melt ink 23 on the screen mesh 21 solidifies. Since the hot melt ink 23 is solid at room temperature, the hot melt ink 23 is heated to approximately 100° C. and ejected in a liquid (fluid) state. Once applied onto the screen mesh 21, the hot melt ink 23 cools down and adheres to the screen mesh 21. The screen mesh 21 can also be used in this state as a screen printing plate.

Further, as shown in FIG. 4, the screen mesh 21 is preferably pressed by the pressure rollers 24 and 25 such that the hot melt ink 23 is filled in the screen mesh 21 in at a high density and the surface thereof is smoothed. The printing plate in which the ink 23 is sufficiently filled in the screen mesh 21 has excellent durability. Moreover, printing ink can be smoothly and uniformly applied onto the printing plate during printing.

A method for manufacturing a screen printing plate in accordance with the second aspect of the present invention includes a step of ejecting a fluid ink blocking material, which forms a pattern of ink blocking material, onto an intermediate transfer member, a step of transferring the ink blocking material on the intermediate transfer member to an ink permeable member, and preferably a step of curing the ink blocking material. In accordance with this method, a screen printing plate having a pattern of ink blocking material formed on the ink permeable member is manufactured.

In this embodiment, the fluid ink blocking material is directly applied imagewise onto the intermediate transfer member, preferably by using an ink jetting device, and then transferred to the ink permeable member. Therefore, the pattern of ink blocking material thus obtained ultimately is spread out so as to be flat and uniform, and has no gaps caused by the ink blocking material being applied in the form of raised dots. Further, in the same way as in the first embodiment, exposure and development processings are unnecessary, and no decrease in image sharpness is caused by irregular reflections of light. As a result, the pattern of ink blocking material having very sharp edges can be formed.

In the ejection step of the present embodiment, the above-mentioned fluid ink blocking material is ejected and adhered onto the intermediate transfer member, which serves as a first image receiving member. The pattern of ink blocking material for blocking ink is formed during printing.

As for the ejection of the ink blocking material, the method in the first embodiment can be used, and the preferable method is the same as that in the first embodiment. Namely, the hot melt ink jet method, in which the ink blocking material which is solid at room temperature is heated and melted such that the ink blocking material which has been melted (is in a fluid state) is ejected, is particularly preferable. The temperature during heating and melting of the ink blocking material, and details and preferable modes of the ink blocking material used are as previously described.

In the present embodiment, the intermediate transfer member is preferably structured such that the temperature thereof is variable. When the ink blocking material is ejected onto the intermediate transfer member, at least an area of the intermediate transfer member to which the ink blocking material is applied is preferably heated. By heating the applied ink blocking material on the intermediate transfer member to the extent that the ink blocking material does not solidify, gaps between dots of the ink blocking material can be eliminated, and a uniform pattern of ink blocking material having little inadequate blocking or irregularities can be formed.

The heating temperature may be any temperature as long as the ink blocking material does not solidify completely. However, the heating temperature is preferably 50 to 110° C., and more preferably 55 to 100° C.

The intermediate transfer member is heated preferably when the ink blocking material is ejected. After ejection (etting) of the ink blocking material, the temperature of the intermediate transfer member is preferably maintained in a predetermined range at least until the ink blocking material is transferred to the ink permeable member in the transfer step, which will be described later.

In this case as well, the heating temperature of the intermediate transfer member may be any temperature as long as the ink blocking material does not solidify completely, and may be preferably within the above-mentioned temperature range.

The configuration of the intermediate transfer member may be appropriately selected from, but is not limited to, known configurations including cylindrical (solid or hollow) substrates of any diameter having circular cross-sections such as so-called rollers and drums, polygonal substrates such as square poles, and planar substrates, according to the purpose or application. Further, the inner structure of the intermediate transfer member may be any structure, such as a hollow structure, a solid structure, or the like.

In the transfer step, the ink blocking material which has been ejected in the above-described ejection step is transferred to the ink permeable member through which ink can permeate.

Transfer may be carried out by any method as long as it enables transfer of the ink blocking material on the intermediate transfer member onto the ink permeable member. Among various methods, in the same way as the pressing in the first embodiment, a transfer method in which the surface of the intermediate transfer member having the ink blocking material applied thereto is made to contact and pressed against the ink permeable member is preferable.

Specifically, transfer can be carried out by using the above-described known substrates including the substrates having a circular cross-section such as so-called rollers and drums, the polygonal substrates such as square poles, and the planar substrates, for example by using a pair of pressure rollers (including heating rollers) or two pressure plates (including hot plates). Accordingly, the ink blocking material is filled into the ink permeable member, and a screen printing plate having a smooth surface can be obtained.

In the present embodiment, as well as the first embodiment, the curing step in which the ink blocking material is irradiated with light is preferably provided subsequent to the transfer step. With the curing step, the strength (durability) of the pattern of ink blocking material provided on the ink permeable member can be further improved.

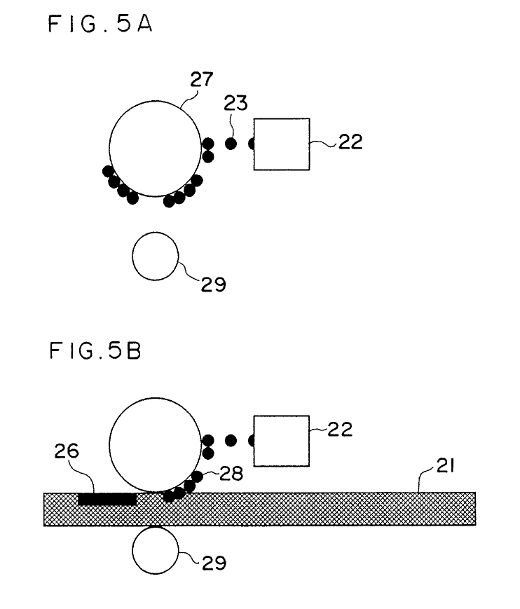

FIGS. 5A and 5B are schematic process drawings for explaining an example in which the screen printing plate in accordance with the second aspect of the present invention is manufactured.

As shown in FIGS. 5A and 5B, the hot melt ink jet head 22 is disposed so that the ejection orifices thereof face the curved surface of a cylindrical intermediate transfer member 27. A pressure roller 29 is provided so as to be made to contact and be pressed against the curved surface of the intermediate transfer member 27 and rotates synchronously with the intermediate transfer member 27. The screen mesh 21 is conveyed while being pressed between the intermediate transfer member 27 and the pressure roller 29.

As shown in FIG. 5A, when the hot melt ink 23 which is solid at room temperature is heated to approximately 100° C., the hot melt ink 23 melts and is jetted (ejected) imagewise from the hot melt ink jet head 22 in a fluid state (ejection step). In this way, a desired image is formed on the curved surface of the intermediate transfer member 27 as the pattern of ink blocking material. At this time, the temperature of at least the curved surface of the intermediate transfer member 27 is controlled by a heating device (not shown) so as to be 70 to 80° C. Thus, the hot melt ink 23 adhering to the curved surface does not solidify completely and is maintained in a state in which the shape of the hot melt ink 23 can be changed.

Subsequently, as shown in FIG. 5B, the screen mesh 21 is conveyed while being pressed (at 2 MPa or more) between the pressure roller 29 and the intermediate transfer member 27. At this time, the hot melt ink 23 on the intermediate transfer member 27 is sequentially transferred to the screen mesh 21 so as to be embedded therein (transfer step). The hot melt ink 23 solidifies and is fixed in the screen mesh 21.

As described above, the hot melt ink 23 is filled in the ink permeable member (screen mesh) at high density. As a result, the dot shape (raised dots) of the hot melt ink 23 formed during ejection is eliminated, thereby obtaining sufficient adhesion between the pattern of ink blocking material and the ink permeable member and mitigating irregularities on the surface of the screen printing plate. Therefore, the screen printing plate having excellent uniformity, excellent durability, and excellent surface property can be manufactured.

<Device for Manufacturing a Screen Printing Plate>

A device for manufacturing a screen printing plate in accordance with the present invention includes an ejection means which ejects a fluid ink blocking material for forming a pattern of ink blocking material on an ink permeable member. The ejection means is used to eject the ink blocking material imagewise onto the ink permeable member, thereby directly forming the pattern of ink blocking material on the ink permeable member. Further, the device may include, if necessary, a means for preparing and processing (such as enlarging or reducing) desired characters, images, or design drawings (i.e., a computer or the like), and a reading means for importing photographic images (i.e., a scanner or the like).

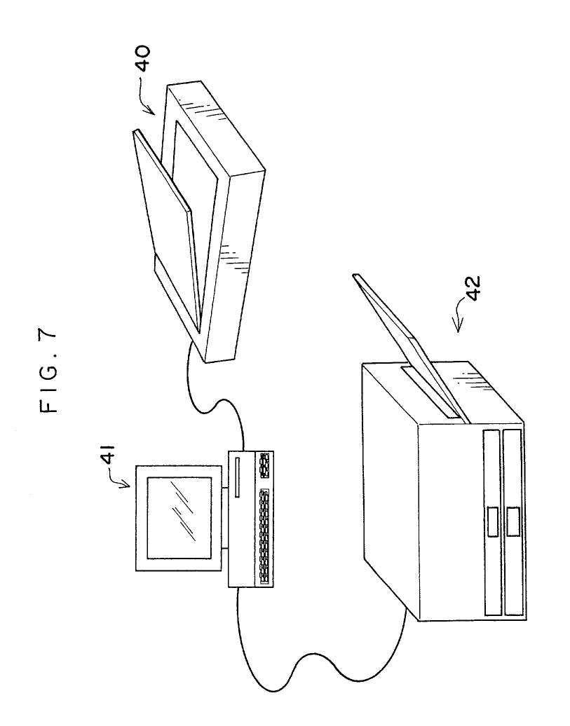

For example, as shown in FIG. 7, a device for manufacturing a screen printing plate 42, a computer 41 which is electrically connected to the device for manufacturing a screen printing plate 42 for transmission of image data thereto, and a scanner (image reading means) 40 which is electrically connected to the computer 41 for transmission of document data thereto may be used.

In this case, a hand-written document (not shown) is prepared, and the document is read by the scanner 40. The data of the read image is transmitted to the computer 41 which is connected to the scanner 40. The image data is subjected to processing, correction, color separation, and the like, to obtain plate data for printing. All data and the like may be directly prepared and processed in the computer. The plate data thus obtained is transmitted to the device for manufacturing a screen printing plate 42 which is connected to the computer 41. In the device for manufacturing a screen printing plate 42, a screen printing plate is manufactured based on the plate data. The above-described screen printing plate in accordance with the present invention can be preferably manufactured by, for example, the following first and second embodiments of the device for manufacturing a screen printing plate.

The device for manufacturing a screen printing plate in accordance with the first aspect of the present invention includes at least an ejection means for ejecting a fluid ink blocking material to form a pattern of ink blocking material, which adheres to an ink permeable member through which ink can permeate and blocks permeation of ink. Preferably, the device further includes an irradiation means. With this structure, a screen printing plate having a pattern of ink blocking material formed on the ink permeable member can be manufactured.

The method for manufacturing a screen printing plate in accordance with the first aspect of the present invention, which has been previously described, is applied to the device of this embodiment. The fluid ink blocking material is applied imagewise to the ink permeable member directly, preferably by an ink jet head or the like. Therefore, exposing and developing means are not necessary, and the device can have a simple structure.

It suffices if the ejection means can eject the fluid ink blocking material. Preferably, the ejection means is appropriately selected from known means by which the ink blocking material can be applied imagewise. Among the known means, a means including an ink jet ejection mechanism such as an ink jet head is preferable, and a hot melt ink jet head, which can eject the ink blocking material in a melted (fluid) state obtained by heating the ink blocking material which is solid at room temperature, is particularly preferable. For example, an existing ink jet head can be used as the ejection means.

When the ink blocking material is ejected (jetted) onto the ink permeable member, the ink blocking material is adhered onto the surface of the ink permeable member. In order to fill in the ink permeable member with the ink blocking material and smooth the surface of the screen printing plate which is ultimately obtained, it is preferable that the device for manufacturing a screen printing plate further includes a means for pressing and/or heating the ink blocking material ejected onto the ink permeable member (i.e., a smoothing means).

The pressing method is as described above. The pressing means is not particularly limited, and a pair of cylindrical (solid or hollow) pressure rollers of any diameters, or pressure plates formed by two planar plates can be used. The pair of cylindrical pressure rollers are two substrates having circular cross-sections and are pressed against and made to contact each other. The heating method is not particularly limited as long as it enables softening or melting of the ink blocking material. The heating means can be appropriately selected from known heating means.

Further, in terms of further filling in the ink permeable member with the ink blocking material in high density, smoothing the surface of the screen printing plate, and reducing the pressure applied thereto, a heating means is preferably used together with the pressing means. Specifically, heating rollers and hot plates are preferable.

The device for manufacturing a screen printing plate may further include the irradiation means for carrying out the curing step in the above-described method for manufacturing a screen printing plate. Irradiation with light by the irradiation means is carried out in order to cure the ink blocking material applied to the ink permeable member. It suffices if all or a portion of the ink blocking material is irradiated with light. Alternatively, the ink blocking material may be irradiated imagewise with light. Further, irradiation of the ink blocking material with light may be carried out by fixing the ink permeable member having the ink blocking material applied thereon and moving a light source from one end of the ink permeable member to the other, by fixing the light source and moving the ink permeable member from one end of the light source to the other, or by moving both the ink permeable member and the light source relative to each other.

Irradiation of the ink blocking material with light is preferably carried out uniformly in terms of quality stabilization.

The light source used for irradiating the ink blocking material with light may be appropriately selected from light sources which emit light having wavelengths to which the ink blocking material or the photo-curing agent is sensitive. Examples of the light source include a fluorescent lamp, a xenon lamp, a UV lamp, and the like. Irradiation strength and irradiation energy during irradiation with light may also be appropriately selected so as to suit the characteristics of the ink blocking material or the photo-curing agent.

As described above, the device includes the ejection means for ejecting (jetting) the ink blocking material, and, if necessary, the pressing means and the irradiation means. Therefore, the device has a simple structure and can be manufactured at low cost. Further, a screen printing plate of good quality can be manufactured inexpensively.

The device for manufacturing a screen printing plate in accordance with the second aspect of the present invention includes an intermediate transfer member, an ejection means for ejecting a fluid ink blocking material to form on the intermediate transfer member a pattern of ink blocking material which blocks permeation of ink, a transfer means for transferring the ink blocking material on the intermediate transfer member onto the ink permeable member, and preferably a curing means. With this structure, a screen printing plate which includes the ink permeable member having the pattern of ink blocking material formed thereon can be manufactured. Details regarding the intermediate transfer member are as described above.

The method for manufacturing a screen printing plate in accordance with the second aspect of the present invention, which has been already described, is applied to the device of the present second embodiment. The fluid ink blocking material is applied imagewise to the intermediate transfer member directly, preferably by an ink jet head or the like, and further transferred onto the ink permeable member. Therefore, exposing and developing means are not necessary, and the device can have a simple structure.

As for the ejection means, the means used in the first embodiment can be used, and the preferable means is also the same as that in the first embodiment. Namely, a hot melt ink jet head, which can eject the ink blocking material in a melted (fluid) state obtained by heating the ink blocking material which is solid at room temperature, is particularly preferable.

The transfer means may be any means as long as it can transfer the ink blocking material on the intermediate transfer member onto the ink permeable member. In the same way as the pressing means in the first embodiment, the preferable transfer means is a means by which the surface of the intermediate transfer member having the ink blocking material applied thereon and the ink permeable member can be pressed against and made to contact each other.

Specific examples of the transfer means include the pair of pressure rollers (including heating rollers) and pressure plates (including hot plates) formed by two planar plates, both of which have been already described. The pair of pressure rollers are two substrates having circular cross-sections, such as so-called rollers or drums, and are pressed against and made to contact each other.

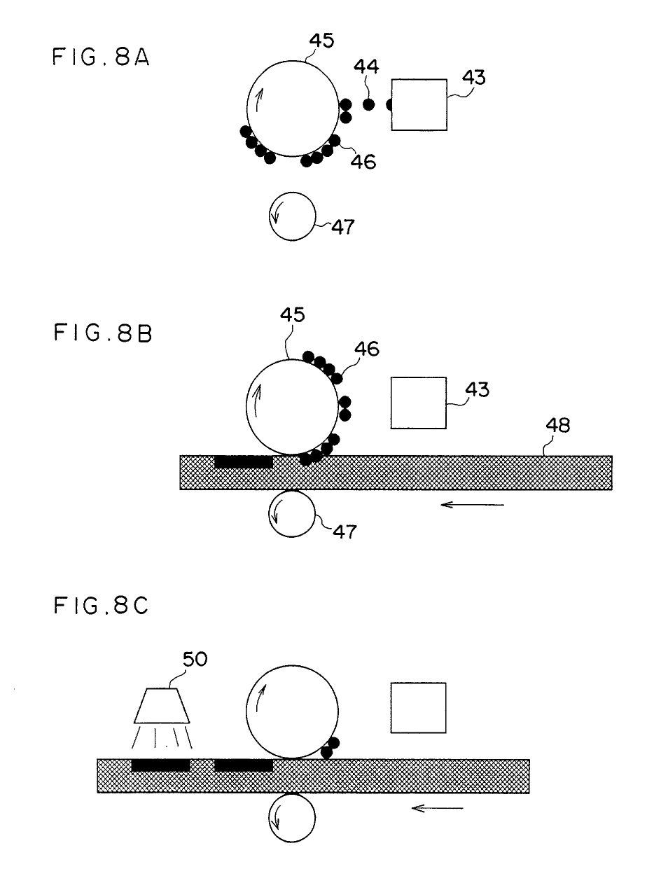

Moreover, for example, as shown in FIGS. 8A through 8C, the device may include an irradiation means for carrying out the curing step of the above-described method for manufacturing a screen printing plate after an ink blocking material 46 has been transferred onto an ink permeable member 48 by the transfer means (see FIG. 8B). FIGS. 8A, 8B, and 8C show an example of the device in which a UV lamp 50 serving as the irradiation means is disposed so as to face the surface of the ink permeable member 48 to which the ink blocking material 46 is transferred.

It suffices if irradiation with light is carried out by the irradiation means so that at least the ink blocking material 46 which has been transferred to the ink permeable member 48 is cured. The irradiation method and the light source are the same as those used in the first embodiment.

With the above-described structure, the device can fill in the ink permeable member with the ink blocking material in high density and manufacture a screen printing plate in which the dot shape of ink formed during ejection is eliminated and the surface of the pattern of ink blocking material is smooth. Further, durability can also be ensured by incorporating the irradiation means into the device.

<Screen Printing Method>

Screen printing is generally carried out using a printing device which is connected to a computer, without using photographic films. Recently, with the rapid progress of computers, printing can be carried out by using characters or image data from the computer, enlarging or reducing design drawings by the computer, and using data of photographic images imported from the scanner.

The screen printing method in accordance with the present invention includes a step of screen-printing an image on a material to be printed by using the above-described screen printing plate of the present invention. A specific example of printing will be described below.

As shown in FIG. 6, a printer 32 having two plate members (supporting substrates) which open and close with one end thereof serving as a rotation axis is prepared. A screen printing plate 33 in accordance with the present invention is attached to one of the two plate members, and a material to be printed 35 is placed on a surface of the other plate member, which surface faces the screen printing plate 33. Ink 30 is applied onto the screen printing plate 33 of the printer 32 and spread out by a squeegee 31. An image can be printed on the material to be printed 35 by the ink 30 passing through a permeation portion 34 and adhering onto the material to be printed 35. Thereafter, desired processings such as heating are carried out, and then printing is completed.

In order to reduce damage caused by the squeegee 31 to the printing plate by as much as possible and to improve image reproducibility, an ink supplying surface of the screen printing plate 33 is preferably set so that the surface of the screen printing plate 33 having the ink blocking material applied thereon faces the material to be printed 35.

Ink generally used in printing, such as blue (B) ink, green (G) ink, red (R) ink, and the like, can be used as printing ink.

<Screen Printing Device>

A screen printing device in accordance with the present invention includes at least a printing means which has the screen printing plate of the present invention and screen-prints an image on a desired material to be printed. The printing means may be any means as long as it includes the screen printing plate of the present invention and enables screen printing.

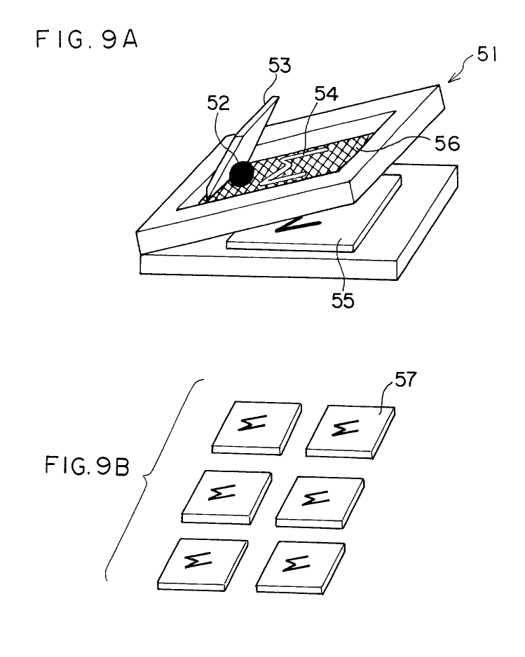

For example, the screen printing device may have a structure shown in FIG. 9A. Namely, a screen printing plate 56 in accordance with the present invention is attached to one of the two plate members which open and close with one end thereof serving as a rotation axis. A surface of the screen printing plate 56 which does not face a material to be printed has a concave portion for ink supply (i.e., an ink supply portion). The other of the two plate members has the surface facing the screen printing plate 56, onto which the material to be printed is placed.

In this structure, when ink 52 is supplied to the ink supply portion and spread out by a squeegee 53, the ink 52 permeates through a mesh portion (“M” portion) 54 of the screen printing plate 56 and adheres to the surface of a steel plate 55, which is the material to be printed. In this way, the “M” portion 54 is printed on the steel plate 57 (FIG. 9B).

<Screen-Printed Matter>

Screen-printed matter in accordance with the present invention is produced by the above-described screen printing method or device of the present invention. Since screen printing is carried out using the screen printing plate of the present invention, images having depth and three-dimensionality can be obtained at high resolution on desired materials to be printed, such as cloths, plastic, printed circuit boards, glass, porcelains, metal plates, three-dimensional objects, and curved materials.

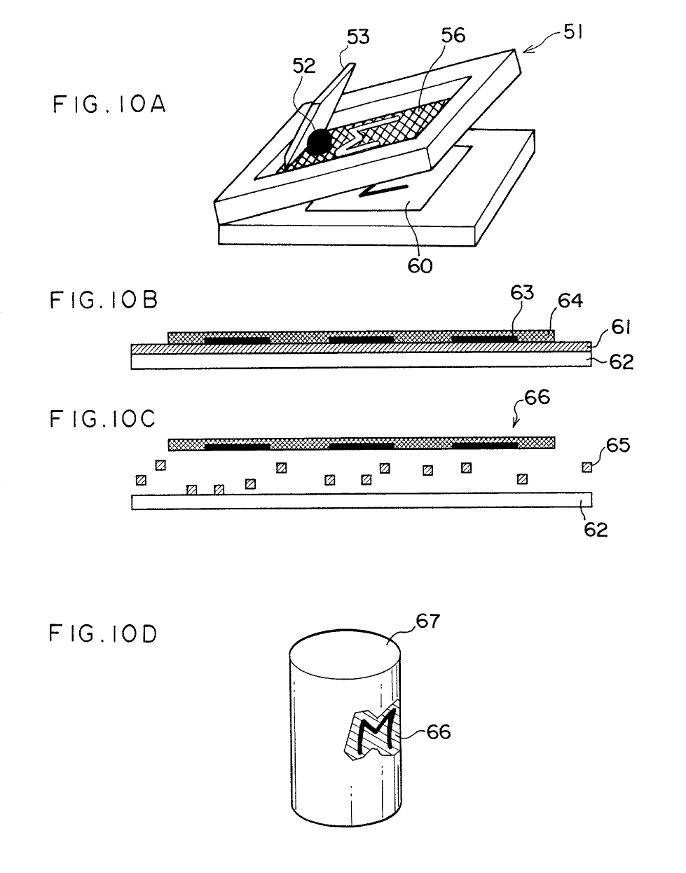

Further, in addition to the above-described method for forming an image directly on a material to be printed, when it is difficult to print an image directly onto a material to be printed such as a three-dimensional object or a curved material, the present invention may use transfer paper which has a water-soluble adhesive layer and thus can be adhered to the material to be printed (see FIGS. 10A through 10D).

### EXAMPLES

The present invention will now be described by, but is not limited to, the following Examples.

### Example 1

An example in which a steel plate was used as a material to be printed will be described below.

First, as shown in FIG. 7, a system comprised of the following components was constructed: the device for manufacturing a screen printing plate 42; the computer 41 which was electrically connected to the device for manufacturing a screen printing plate 42 so as to transmit image data thereto; and the scanner (image reading means) 40 which was electrically connected to the computer 41 so as to transmit document data thereto.

Next, a hand-written document (not shown) was prepared and read by the scanner 40. Data of the image read by the scanner 40 was transmitted to the computer 41 which was connected to the scanner 40 and was subjected to processing, correction, color separation, and the like to prepare plate data for printing. Subsequently, the plate data thus obtained was transmitted to the device for manufacturing a screen printing plate 42, which was connected to the computer 41.

The screen printing plate of the present invention was manufactured as follows in the device for manufacturing a screen printing plate 42 having a structure shown in FIGS. 8A through 8C.

As shown in FIG. 8A, a hot melt ink jet head 43 was disposed at a position where ejection orifices for ejecting a fluid ink blocking material faced the curved surface of a cylindrical intermediate transfer member 45. A pressure roller 47 was provided so as to contact and press an ink permeable member which was disposed between the intermediate transfer member 45 and the pressure roller 47. Further, the pressure roller 47 rotated synchronously with the intermediate transfer member 45 in the direction of the arrow so as to convey a screen mesh 48, which was the ink permeable member.

When the device for manufacturing a screen printing plate 42 having the above structure was activated, the intermediate transfer member 45 and the pressure roller 47 rotated. At the same time, the hot melt ink jet head 43 was heated to 130° C., and a hot melt ink 44 was jetted imagewise onto the surface of the intermediate transfer member 45 based on the plate data obtained above (ejection step).

The hot melt ink 44 was a photo-curing ink which was cured by UV rays. Specifically, ink including a mixture of tetraamide and monoamide as a principal component and further including a terpene polymer (tackifier) and mono and poly unsaturated carboxylic acid ester (plasticizer) was used as the hot melt ink 44. The hot melt ink 44 was prepared so as to be solid at room temperature and fluid at approximately 100° C.

The temperature of the intermediate transfer member 45 was controlled to about 70 to 80° C. so that applied ink 46 did not solidify completely (FIG. 8A). In this state, as shown in FIG. 8B, the hot melt ink 44 was transferred onto the screen mesh 48 by being pressed against the screen mesh 48 (N #175 (the number of mesh: 175 lines/inch), manufactured by NBC Inc.) which was conveyed between the intermediate transfer member 45 and the pressure roller 47 (transfer step). The pressure during transfer was 5 MPa. The pressure was appropriately selected so that the hot melt ink 44 was completely filled in the mesh. In general, the smaller the mesh size, the more difficult it becomes for ink to be filled in the mesh. Therefore, high pressure is preferable.

The UV lamp 50 which served as the irradiation means was disposed at the downstream of the intermediate transfer member 45, and the pressure roller 47 was disposed along the conveying path of the screen mesh 48 so as to irradiate light onto at least the hot melt ink (ink blocking material) 44 which had been transferred to the screen mesh 48.

After the hot melt ink 44 had been transferred as described above, the screen mesh 48 was further conveyed in the direction of the UV lamp 50. When the screen mesh 48 was conveyed to the vicinity of the UV lamp 50, as shown in FIG. 8C, the UV lamp 50 irradiated light (irradiation energy: 250 to 500 mJ/cm²) onto the surface of the screen mesh 48 to which the ink blocking material 44 had been transferred (curing step). The screen printing plate was obtained in the above-described manner.

Next, as shown in FIG. 9A, a printing device 51 formed by two plate members was prepared. The two plate members were structured so as to open and close with one end thereof serving as a rotation axis. One of the plate members had an opening in the center thereof, and the screen printing plate 56 obtained in the above-described manner was attached to the one of the plate members so that a concave portion for ink supply (ink supply portion) was formed at the side not facing a material to be printed. A steel plate (i.e., the material to be printed) 55 was placed on the surface of the other plate member, which surface faced the screen printing plate 56. At least a permeating portion 54 of the screen printing plate 56 was supported by the plate member (supporting substrate) having the opening at the permeating portion (the “M” portion) 54, which was a mesh portion.

Printing was carried out on the steel plate 55 by supplying the ink 52 to the ink supply portion and spreading the ink 52 out using the squeegee 53 so that the ink 52 passed through the permeating portion (the “M” portion) 54 of the screen mesh 56. At this time, in order to reduce damage caused by the squeegee 53 to the printing plate by as much as possible, an ink supplying surface of the screen printing plate 56 was the surface of the screen printing plate 33 to which the ink blocking material 44 was not transferred. Multicolor printing could also have been carried out by repeating the above steps the number of times corresponding to the number of colors. After the printing described above was completed, the steel plate 57 was dried.

As described above, the screen printing plate was able to be simply manufactured in a small number of steps and at low cost. Further, the screen printing plate thus obtained had a pattern of ink blocking material having very sharp edges and also had excellent durability. Finally, the printed image formed on the steel plate by the screen printing had high resolution.

### Example 2

In place of the steel plate used in Example 1, a cylindrical object was used as a material to be printed. A printed image was formed on the curved surface of the cylindrical object in the following manner.

First, the system which was the same as that in Example 1 was constructed, and the screen printing plate of the present invention was manufactured by using the steps which were the same as those in Example 1.

Subsequently, the printing device which was the same as that in Example 1 (see FIG. 10A) was prepared. In place of the steel plate used in Example 1, transfer paper (a material to be printed) was placed on the surface of the other plate member, which surface faced the screen printing plate 56.

As shown in FIG. 10B, unlike ordinary paper, the transfer paper used herein had a base paper 62 and a water-soluble layer 61 coated thereon. The water-soluble layer 61 was formed by a water-soluble lubricant which contained dextrin as a principal component.

Accordingly, printing was carried out such that the ink 52 was supplied to the ink supplying portion and spread out by the squeegee 53, so that the ink 52 passed through the permeating portion (the “M” portion) 54 of the screen mesh 56. As a result, a print pattern 63 was printed on the water-soluble layer 61.

Next, an ink permeable member having no ink blocking material applied thereon was set in the plate member in place of the screen mesh 56. Then, a composition for a protective film which contained butyral resin as a principal component was supplied to the ink supplying portion. In this way, as shown in FIG. 10B, a protective film 64 which contained butyral resin as a principal component was formed on the water-soluble layer 61 having the print pattern 63 printed thereon. Since the protective film 64 was flexible, a printed image was fixed without deformation by providing the protective film. Therefore, an image was able to be favorably printed and adhered onto the material to be printed without deformation.

Next, at least the transfer paper was immersed in water. As shown in FIG. 10C, the base paper 62 was peeled off by dissolving the water-soluble layer 61 in water, and the print pattern 63 together with the protective film 64 was separated. (The combination of the print pattern 63 and the protective film 64 is referred to as an image portion 66.) As shown in FIG. 10D, the separated image portion 66 was adhered and transferred to the curved surface of a cylindrical object 67. Thereafter, the cylindrical object 67 was dried and calcined in order to fix the image portion 66 on the cylindrical object 67.

As described above, the printed image of high resolution formed by screen printing was also able to be formed at high resolution on the curved surface of the three-dimensional object. In the same way as in Example 1, the screen printing plate was able to be simply manufactured in a small number of steps and at low cost. The screen printing plate thus obtained had a pattern of ink blocking material having very sharp edges and also had excellent durability.

According to the present invention, a screen printing plate, which includes a sharply patterned ink blocking material and can form printed images of high resolution, can be provided. Moreover, a method and a device for manufacturing a screen printing plate, in which the screen printing plate having no unclear pattern edges formed during exposure due to irregular reflections of light and enabling formation of patterns having sharp edges and printed images of high resolution, can be simply formed in a small number of steps and at low cost, can be provided.

Further, according to the present invention, a screen printing method and a screen printing device in which printed images can be obtained at high resolution using the screen printing plate of the present invention and a small amount of printing is possible at low cost, and a screen-printed matter, which is printed at high resolution using the screen printing plate of the present invention, can be provided.

Furthermore, in the present invention, a conventional ink jet printer can be used to form a pattern of ink blocking material, and no other steps are necessary. Therefore, as compared with prior art, costs can be significantly reduced in the manufacture of the screen printing plates. Even for a small amount of printing, printing costs are not increased by manufacturing of printing plates. Accordingly, application of screen printing to fields where screen printing has not been conventionally used (to technical fields where screen printing is considered to be unfavorable in terms of cost) is expected.

What is claimed is:

1. A screen printing plate comprising:
an ink permeable member through which ink can permeate;
a pattern of ink blocking material adhered to the ink permeable member and blocking the permeation of ink through the ink permeable member; and
the ink blocking material comprising a solidified fluid material which is ejected onto the ink permeable member.

2. The screen printing plate of claim 1, wherein the ink blocking material adhered to the ink permeable member is solidified by applying at least one of pressure and heat to the ink permeable member.

3. A screen printing plate comprising:
an ink permeable member through which ink can permeate; and
a pattern of ink blocking material adhered to the ink permeable member and blocking the permeation of ink through the ink permeable member, the ink blocking material comprising a solidified fluid material, which has been ejected onto a transfer member and transferred from the transfer member to the ink permeable member.

4. The screen printing plate of claim 1, wherein the ink blocking material is ejected using an ink jetting device.

5. The screen printing plate of claim 1, wherein the ink permeable member comprises a mesh.

6. The screen printing plate of claim 1, further comprising a supporting substrate for supporting the ink permeable member.

7. The screen printing plate of claim 6, wherein the supporting substrate has an opening so that the surface of the ink permeable member is exposed.

8. The screen printing plate of claim 6, wherein at least a portion of the supporting substrate is removably provided.

9. The screen printing plate of claim 1, wherein the ink blocking material comprises wax.

10. The screen printing plate of claim 1, wherein the ink blocking material is solid at a temperature which is no more than room temperature.

11. The screen printing plate of claim 1, wherein the ink blocking material is photo-curable.

12. The screen printing plate of claim 1, wherein the ink blocking material comprises a photo-curing agent.

13. A method for manufacturing a screen printing plate, comprising the steps of:
providing an ink permeable member through which ink can permeate; and
ejecting a fluid ink blocking material for blocking permeation of ink onto the ink permeable member such that a pattern of ink blocking material adheres to the ink permeable member, thereby forming the pattern of ink blocking material on the ink permeable member.

14. A method for manufacturing a screen printing plate, comprising the steps of:
providing a transfer member;
ejecting a fluid ink blocking material for blocking permeation of ink onto a transfer member such that a pattern of ink blocking material adheres to the transfer member;
providing an ink permeable member through which ink can permeate; and
transferring the pattern of ink blocking material adhering to the transfer member onto the ink permeable member such that the pattern of ink blocking material is formed on the ink permeable member.

15. The method of claim 13, wherein the ink blocking material is ejected using an ink jetting device.

16. A device for manufacturing a screen printing plate from an ink permeable member through which ink can permeate using ink blocking material which adheres to the ink permeable member for blocking permeation of ink, wherein said device comprises an ejection means for ejecting a fluid ink blocking material onto the ink permeable member so as to form a pattern of ink blocking material thereon.

17. The device of claim 16, further comprising a means for applying at least one of pressure and heat to the ink blocking material ejected onto the ink permeable member.

18. A device for manufacturing a screen printing plate from an ink permeable member through which ink can permeate using ink blocking material which adheres to the ink permeable member for blocking permeation of ink, said device comprising:
a transfer member;
an ejection means for ejecting onto the transfer member a fluid ink blocking material for forming a pattern of ink blocking material; and
a transfer means for transferring the pattern of ink blocking material on the transfer member to the ink permeable member,
whereby the pattern of ink blocking material is formed on the ink permeable member.

19. The device of claim 16, wherein the ejection means for ejecting the ink blocking material onto the transfer member includes an ink jet ejection mechanism.

20. A screen printing method comprising a step of screen-printing an image on a material to be printed by using the screen printing plate of claim 1.

21. A screen printing device comprising means for screen-printing an image on a material to be printed by using the screen printing plate of claim 1.

22. A screen-printed matter obtained by the screen printing device of claim 21.
